(19) United States
(12) Patent Application Publication
(10) Pub. No.: US 2008/0304136 A1
(43) Pub. Date: Dec. 11, 2008

(54) Optical parametric oscillator

(75) Inventors: Hong Ki Kim, Yongin (KR); Bae Kyun Kim, Seongnam (KR); June Sik Park, Yongin (KR); Dong Hoon Kang, Yongin (KR); Sang Su Hong, Suwon (KR); Kum Young Ji, Seoul (KR); Chang Yun Lee, Suwon (KR); Tak Gyum Kim, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/155,584

(22) Filed: Jun. 6, 2008

(30) Foreign Application Priority Data
Jun. 8, 2007 (KR) 10-2007-56332

(51) Int. Cl. G02F 1/35

(52) U.S. Cl. 359/330

(57) ABSTRACT

There is provided an optical parametric oscillator capable of converting a wavelength in a broader range and generating an output beam with high efficiency. The optical parametric oscillator includes: a non-linear optical material optical parametrically converting a beam pumped from a laser; and input and output optical devices opposing each other, the input and output optical devices guiding the optical parametrically-converted beam to the non-linear optical material to oscillate, wherein the input optical device includes an input optical mirror guiding the pumping beam into the oscillator, and the output optical device includes a plurality of output optical mirrors each guiding the optical parametrically-converted beam outside the oscillator, the output optical mirrors having reflectivities different from one another with respect to a wavelength of the optical parametrically-converted beam.

### CROSS-REFERENCE TO RELATED APPLICATIONS

This application claims the priority of Korean Patent Application No. 2007-56332 filed on Jun. 8, 2007, in the Korean Intellectual Property Office, the disclosure of which is incorporated herein by reference.

### BACKGROUND OF THE INVENTION

1. Field of the Invention

The present invention relates to an optical parametric oscillator, more particularly, capable of converting a wavelength in a broader range and generating an output beam with high efficiency.

2. Description of the Related Art

Recent years have seen development of various kinds of lasers such as a gas laser using, e.g., CO₂ or HeNe, a solid-state laser using, e.g., Ti: sapphire or Nd:YAG, a semiconductor laser using, e.g., AlGaAs or GaN, and a fiber laser, using, e.g., Er:Fiber. However, such lasers characteristically cannot output a beam in a broad wavelength range. Therefore, several types of lasers utilizing ions of a transitional metal, e.g., Mn, Co, or Ti as an active material have been developed as the solid-state laser for converting a wavelength. Yet these lasers convert a wavelength in a limited range.

The development of such lasers has been followed by an urgent need for the wavelength conversion laser. The wavelength conversion laser can find its broad application from pure research (laman spectroscope) to commercial use such as medical equipment and measuring equipment. That is, laser oscillation has been in need in all wavelength ranges.

Moreover, buoyed by development of a high output pulse laser (nano or femtosecond laser), a second harmonic generation (SHG) using secondary non-linearity of a non-linear medium has been discovered. This has led to a technology of converting a wavelength using the SHG. However, this SHG-based laser outputs a beam having a wavelength that is a half of a fundamental wave, thus placing limitation on producing a wavelength laser capable of converting wavelength continuously.

To overcome this drawback, a technology of manufacturing an optical parametric oscillator (OPO) has been developed. This technology involves employing different frequency generation (DFG), one of SHG phenomena to manufacture the OPO. The DFG indicates a phenomenon in which a beam of a high energy is incident on a non-linear medium and divided into beams of a lower energy, thereby enabling the wavelength conversion laser to perform oscillation continuously. For example, a beam with a wavelength of 355 nm outputted by third harmonic generation (THG) from an Nd: YAG laser is made incident on a BaB₂O₄ crystal and then oscillators are placed on both ends of the crystal, respectively to manufacture the OPO system. This produces a laser capable of converting a wavelength continuously in a range from 405 nm to 2,000 nm.

The oscillator of the OPO system necessitates input and output optical mirrors as a cavity mirror. A fundamental beam, when incident on the oscillator, oscillates between the optical mirrors and amplified to a predetermined level. Therefore, reflectivity and transmissivity of the input and output mirrors determine power of the beam outputted. This accordingly highlights importance of a coating technique for adjusting reflectivity of a pumping beam, a signal beam and an idler beam. However, in a case where the OPO system has a broad conversion wavelength range, e.g., from 400 nm to 2,000 nm, it is not easy to ensure uniform reflectivity of the optical mirrors throughout an entire wavelength range.

FIG. 1 is a schematic configuration view illustrating an optical parametric oscillator 20 and a laser 10 in a conventional wavelength conversion laser apparatus. The optical parametric oscillator 20 includes an input optical mirror 21, an output optical mirror 23 and a non-linear optical material 22 disposed between the input and output mirrors.

A pumping beam L1 pumped from the laser 10 passes through the input optical mirror 21 and enters the non-linear optical material 22. The pumping beam L1 is optical parametrically-converted through the non-linear optical material 22. A portion of the optical parametrically-converted beam L3 is transmitted L4 through the output optical mirror 23 and the other portion of the optical parametrically-converted beam L3 is reflected. The reflected portion L5 of the beam enters the non-linear optical material 22 again, is amplified and guided to the outside L6. In turn, the input optical mirror 21 reflects the beam guided to the outside. This beam enters the non-linear optical material 22 again. Through these processes, the pumping beam L1 is converted into relatively high-output beams having two different wavelengths, i.e., signal beam and idle beam. Here, inside the oscillator, beams with three different wavelengths, i.e., pumping beam L1, signal beam and idler beam L4 are interactively converted in wavelengths thereof. The output beam has an intensity determined by transmissivity or reflectivity of the output optical mirror.

At this time, transmissivity is inversely proportional to reflectivity. A determining factor of this transmissivity or reflectivity is a thin film applied on a surface of the optical mirror. However, the output optical mirror 23 cannot have desired transmissivity and reflectivity for beams of different wavelengths simultaneously. Particularly, with a greater range of the converted wavelength, it is harder to adjust transmissivity of the mirror.

FIG. 2 is a graph illustrating reflectivity with respect to wavelength of a beam in the output optical mirror of the conventional optical parametric oscillator. Referring to FIG. 2, a beam exhibits reflectivity of 95% at a wavelength of 355 nm but shows low reflectivity of 10% at the other wavelengths.

As a result, there has been a need for developing an optical parametric oscillator capable of outputting a laser beam of a broader range to a usable level.

### SUMMARY OF THE INVENTION

An aspect of the present invention provides an optical parametric oscillator capable of converting a wavelength in a broader range and generating an output beam with high efficiency.

According to an aspect of the present invention, there is provided an optical parametric oscillator including: a non-linear optical material optical parametrically converting a beam pumped from a laser; and input and output optical devices opposing each other, the input and output optical devices guiding the optical parametrically-converted beam to the non-linear optical material to oscillate.

The input optical device may include an input optical mirror guiding the pumping beam into the oscillator.

The output optical device may output the optical parametrically-converted beam to the outside. The output optical device may include a plurality of output optical mirrors each guiding the optical parametrically-converted beam outside the oscillator, the output optical mirrors having reflectivities different from one another with respect to a wavelength of the optical parametrically-converted beam. At least one of the output optical mirrors may reflect the optical parametrically-converted beam.

Each of the output optical mirrors may have a dielectric layer applied thereon. The dielectric layer may include a plurality of dielectric layers. Also, each of the output optical mirrors may have a metal layer applied thereon. In addition, each of the output optical mirrors may include a high-refractivity material selected from a group consisting of LiNbO₃, LiIO₃, AgGaS₂, ZnGeP₂, Te and glass.

The input optical mirror may include: a first input optical mirror reflecting the pumping beam to be guided into the non-linear optical material and transmitting the optical parametrically-converted beam; and a second input optical mirror reflecting the optical parametrically-converted beam passed through the first input optical mirror.

The first input optical mirror may be a dichroic mirror. The first input optical mirror reflects the pumping beam from the laser to enter the oscillator, thus required to have as high reflectivity as possible with a respect to the pumping beam. For example, the first input optical mirror may have a reflectivity of at least 95% with respect to the pumping beam from the laser.

The second input optical mirror may have a surface applied with a metal selected from a group consisting of aluminum, sliver and gold.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration view illustrating an optical parametric oscillator and a laser in a conventional wavelength conversion laser apparatus;

FIG. 2 is a graph illustrating reflectivity with respect to wavelength of a beam in an output optical mirror of a conventional optical parametric oscillator;

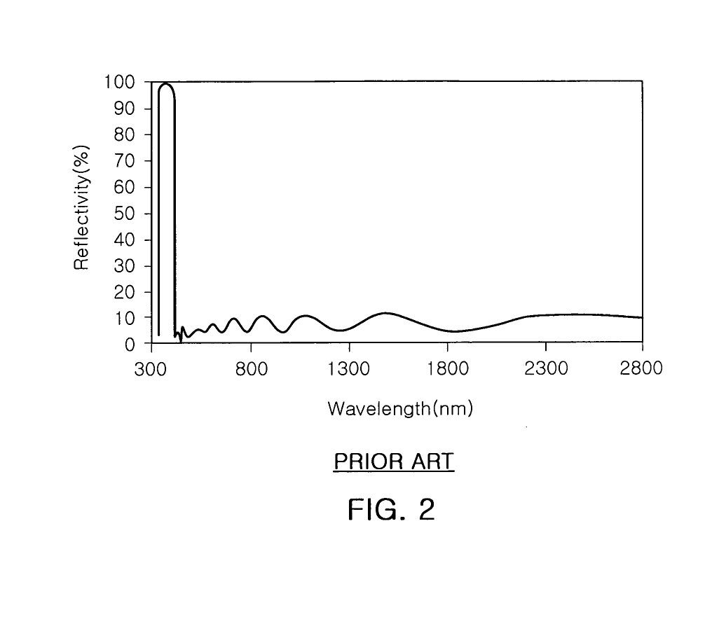

FIG. 3 is a schematic configuration view illustrating an optical parametric oscillator and a laser according an exemplary embodiment of the invention; and

FIG. 4 is a schematic configuration view lustrating an optical parametric oscillator including a plurality of input and output optical mirrors and a laser according to another exemplary embodiment of the invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art.

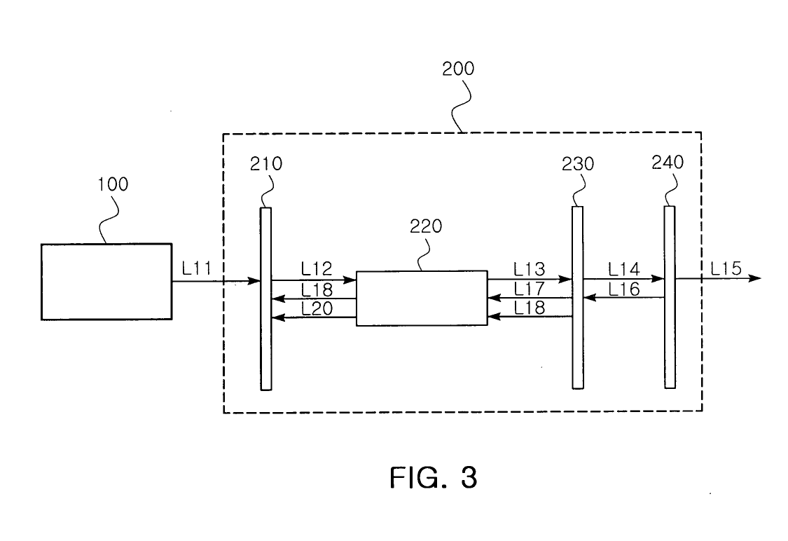

FIG. 3 is a schematic configuration view illustrating an optical parametric oscillator and a laser according an exemplary embodiment of the invention. The optical parametric oscillator 200 of the present embodiment includes a non-linear optical material 220 and input and output optical devices. The non-linear optical material 220 optical parametrically converts a beam L11 pumped from a laser 100. The input and output optical devices oppose each other, and guide the optical parametrically-converted beam to the non-linear optical material to oscillate.

The input optical device includes an input optical mirror 210 guiding the pumping beam L11 into the oscillator 200. The output optical device includes a plurality of output optical mirrors 230 and 240 each guiding the optical parametrically-converted beam L13 outside the oscillator 200. The output optical mirrors 230 and 240 have reflectivities different from each other with respect to a wavelength of the optical parametrically-converted beam. In the present embodiment, the input optical device is configured as the input optical mirror 210 and the output optical device is configured as the plurality of output optical mirrors 230 and 240.

The laser 100 generates the pumping beam L11 of a single wavelength. The pumping beam L11 from the laser 100 is optical parametrically-converted into a beam with a different wavelength from the wavelength of the pumping beam L11 through the non-linear optical material 220. The optical parametrically-converted beam oscillates inside the optical parametric oscillator 200. Therefore, the wavelength conversion laser apparatus can be configured using the laser 100 and the optical parametric oscillator 200 including the non-linear optical material 220 and the plurality of optical mirrors.

The pumping beam L11 is incident on the input optical mirror 210. The input optical mirror 210 transmits the pumping beam L11 inputted from the outside to be guided into the optical parametric oscillator 200. Also, the input optical mirror 210 reflects the beams reflected by the output optical mirrors 230 and 240, i.e., beams L16, L17, and L18 and passed through the non-linear optical material 220, i.e., beams L18 and L20. The beams L18 and 120 reflected from the input optical mirror 210 propagate toward the non-linear optical material 220 again and travel repeatedly inside the optical parametric oscillator 200 to oscillate. Thus the beam L15 finally outputted from the optical parametric oscillator 200 is amplified over the optical parametric converted beam.

The non-linear optical material 220 optical parametrically converts the beam L12 transmitted through and made incident on the input optical mirror 210. The non-linear optical material 220 with non-linear characteristics are altered in optical properties due to change in polarization characteristics when an external electric field is applied thereto. These non-linear characteristics are categorized into a linear optical phenomenon, a secondary non-linear optical phenomenon and a tertiary non-linear optical phenomenon according to a corresponding term pertinent to an electric field, in a non-linear equation defining an external electric field and polarization inside a material.

Among these, the secondary non-linear beam phenomenon includes secondary harmonic wave generation, sum frequency generation and difference frequency generation, and optical parametric generation. By the secondary harmonic wave, an output beam having a frequency twice greater than a frequency of an incident beam is generated. By the sum frequency generation and difference frequency generation, the sum and difference frequencies of two incident beams are generated, respectively. Also, by optical parametric generation, an incident beam is converted into beams having two different frequencies from each other.

The optical parametric oscillator 200 utilizes a phenomenon in which a beam with one frequency is optical parametrically-converted to generate beams with two different frequencies from each other. In the beams with two different frequencies, one beam with a higher frequency is referred to as a signal beam and the other beam with a lower frequency is referred to as an idler beam. Therefore, the beam L12 incident through the input optical mirror 210 is optical parametrically-converted by interaction with the non-linear optical material 220 into a beam L13 including a signal beam and an idle beam having different frequencies from each other.

The non-linear optical material 220 outputs the incident beam L12 as the converted beam L13 including the signal beam and the idle beam. The converted beam L13 may have a wavelength varied by characteristics and position of the non-linear optical material 220. In a case where the non-linear optical material 220 is a non-linear crystal, the converted beam L13 can be adjusted in wavelength by changing a position of crystal lattice.

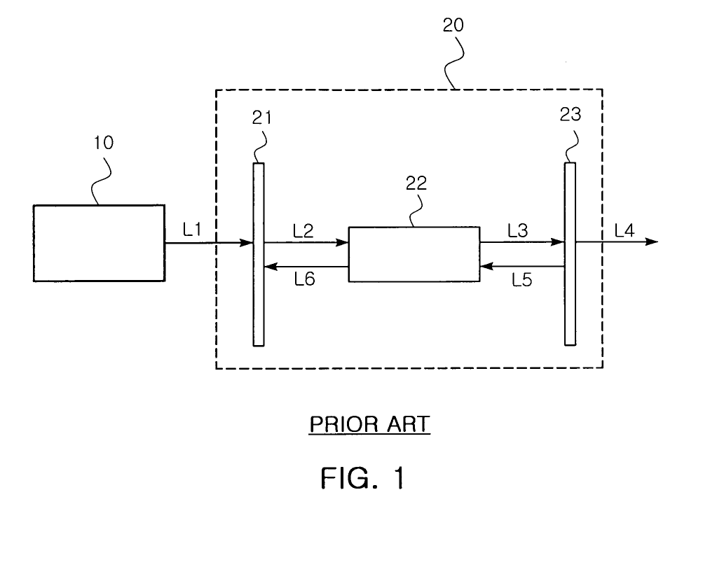

The output optical mirrors 230 and 240 reflect the optical parametrically-converted beam L13. More specifically, the output optical mirrors 230 and 240 reflect a portion of the optical parametric converted beam L13 to be guided into the oscillator, and transmit and output the other portion of the beam L13. Unlike the conventional optical parametric oscillator (see FIGS. 1 and 3), the optical parametric oscillator 200 of the present embodiment includes the plurality of output optical mirrors 230 and 240. FIG. 3 illustrates the two output optical mirrors 230 and 240 but may employ at least three output optical mirrors having reflectivities different from one another with respect to a wavelength of the optical parametrically-converted beam to cover a wavelength range of a desired conversion output beam.

Referring to FIG. 3, of the output optical mirrors 230 and 240, one closer to the non-linear optical material 220 is referred to as a first output optical mirror 230 and the other output optical mirror is referred as a second output optical mirror 240. Here, the first output optical mirror 230 and the second output optical mirror 240 reflect the beams L13 and L14 to a predetermined level or more to have wavelengths different from each other.

That is, the first output optical mirror 230 and the second output optical mirror 240 have different ref lectivities with respect to the beam of a single wavelength, e.g., the wavelength of the beam L13 or the wavelength of the beam L14. For example, the first output optical mirror 230 has a reflectivity of 80% with respect to the wavelength of the beam L13 and 20% reflectivity with respect to the wavelength of the beam L14. On the other hand, the second output optical mirror 240 may have a reflectivity of 25% with respect to the wavelength of the beam L13 and a reflectivity of 80% with respect to the wavelength of the beam L14. Here, the optical parametric oscillator 200 can optical parametrically convert or amplify the beam L13 or L14 having different wavelengths from each other. Therefore, the optical parametric oscillator 200 can convert the beam with a single wavelength L11 incident from the laser 100 into the beams with two different wavelength ranges.

Again, for example, the beam L13 may have a wavelength of 400 nm to 600 nm, and the beam L14 may have a wavelength of 600 nm to 1000 nm. When it is assumed that the beam incident from the laser 100 is a beam with a single wavelength of 355 nm, the non-linear optical material 220 can be adjusted in characteristics and position to output the beam L13 or the beam L14. Here, the beam L13, when outputted, is reflected to a predetermined level or more by the first output optical mirror 230 and then guided back into the oscillator to oscillate. On the other hand, the beam L14, when outputted, is reflected to a predetermined level or more by the second output optical mirror 240 to oscillate. Accordingly, the optical parametric oscillator 200 may generate an output beam L15 having a wavelength ranging from 400 nm to 600 nm, or from 600 nm to 1000 nm. In a case where an output optical mirror (not shown) is further employed to reflect a beam with a wavelength of 1000 nm to 1400 nm to a predetermined level or more, the optical parametric oscillator 200 may convert an incident beam having a single wavelength of 355 nm to a beam having a wavelength of 1000 nm to 1400 nm. Here, “a predetermined level or more” denotes a sufficient level enabling the reflected beam to be guided into the oscillator to be amplified.

Also, in a case where a conversion ratio of the non-linear optical material 220 is not 100% with respect to the incident pumping beam L11, the oscillator is configured in view of loss of the pumping beam such that the first output optical mirror 23 reflects the pumping beam not converted from the non-linear optical material 220 and the second output optical mirror 240 reflects the beam converted by the optical parametric oscillator 400.

The output optical mirrors 230 and 240 each may be a mirror having a dielectric layer applied thereon. The dielectric layer applied may be a multi-layer structure. Moreover, each of the output optical mirrors 230 and 240 may be a mirror having a metal layer applied thereon. Furthermore, the output optical mirrors 230 and 240 may be formed of one of a high-refractivity crystal such as LiNbO₃, LiIO₃, AgGaS₂, ZnGeP₂, and Te, and an amorphous material such as glass. Alternatively, the dielectric material may be applied on the glass in a single layer or multiple layers to adjust refractivity.

Alternatively, the output optical mirrors 230 and 240 can be relatively adjusted in position in the optical parametric oscillator 200 to adjust relative phases of the pumping beam L11 or L12 with respect to each other, and the signal beam and idler beam of the optical parametrically-converted beam L13.

When the pumping beam L11 is guided into the optical parametric oscillator 200 through the input optical mirror 210 and optical parametrically-converted through the non-linear optical material 220, the converted beam L13 is reflected on one of the output optical mirrors 230 and 240 according to the wavelength thereof. In a case where the first output optical mirror 230 can reflect the converted beam L13, the converted beam L13 becomes a reflected beam L17 to be returned to the non-linear optical material 220. In a case where the first output optical mirror 230 cannot reflect the converted beam L13, the converted beam L13 passes through the first output optical mirror 230 and reaches the second output optical mirror 240. The second output optical mirror 240 reflects the beam L14 passed through the first output optical mirror 230 to be returned back to the optical parametric oscillator 200. The returned beam L17 or L18 passes through the non-linear optical material 220 and is reflected again on the input optical mirror 210 to propagate through the non-linear optical material 220 at repeated times.

When the reached beam is identical in wavelength and wavelength condition, the output optical mirrors 230 and 240 reflect a portion of the reached beam and transmit the other portion of the reached beam. Also when the reached beam is not identical in wavelength condition, the output optical mirrors 230 and 240 transmit the beam entirely. The output beam L15 has an output value equal to a total output of the beam transmitted. Then, the optical parametric converted beam L13 obtains gain by passing through the non-linear optical material 220 in the optical parametric oscillator 200. This accordingly assures the output beam L15 of desired high output.

Although not shown in FIG. 3, the optical parametric oscillator 200 may employ a collimating lens (not shown) for focusing a pumping beam from the laser 100 to allow the beam to be guided from the laser 100 with efficiency. Also, the optical parametric oscillator 200 may further include a prism (not shown) for separating the signal beam and the idle beam from the output beam L15.

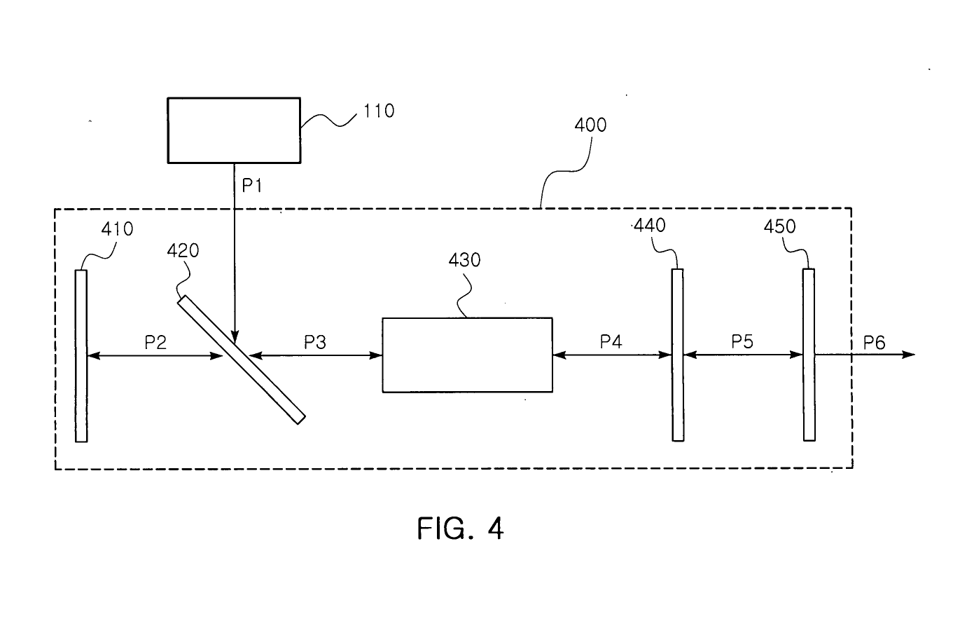

FIG. 4 is a schematic configuration view illustrating an optical parametric oscillator 400 including two output optical mirrors 440 and 450 and two input optical mirrors 410 and 420, and a laser 110 according to another exemplary embodiment of the invention. In the laser and the optical parametric oscillator of FIG. 4, the non-linear optical material, the first output optical mirror, and the second output optical mirror are identical to those shown in FIG. 3 and thus will not be describe in further detail.

The optical parametric oscillator 400 shown in FIG. 4 includes the two input optical mirrors 410 and 420. Of the input optical mirrors 410 and 420, the first input optical mirror 420 reflects a pumping beam from the laser 110, and transmits a beam optical parametrically-converted through the non-linear optical material 430. The second input optical mirror 410 reflects the optical parametrically-converted beam transmitted from the first input optical mirror 420.

The pumping beam from the laser 110, when guided into the optical parametric oscillator 400 on a P1 path, is reflected on the first input optical mirror 420. Here, at least 95% of the pumping beam may be reflected. The reflected pumping beam enters the non-linear optical material 430 on a P3 path to be optical parametrically-converted, and then reaches the first output optical mirror 440 on a P4 path. The reached beam is reflected on a P4 path or P5 path on the first output optical mirror 440 or the second output optical mirror 450 according to a wavelength of the converted beam and then returned to the non-linear optical material 430.

The converted beam passing through the non-linear optical material 430 reaches the first input optical mirror 420 through the P3 path, and reaches the second input optical mirror 410 since the first input optical mirror 420 reflects the pumping beam but transmits the optical parametrically-converted beam. The second input optical mirror 410 reflects the reached converted beam to be returned into the optical parametric oscillator 400. Through these processes, the converted beam which is to be lost when passing through the single input optical mirror can be returned into the optical parametric oscillator 400 to thereby increase output of a final output beam.

The first input optical mirror 420 may be a dichroic mirror. The first input optical mirror 420 may employ the dichroic mirror to reflect a beam of a specific wavelength and transmit a beam of other specific wavelength. The dichroic mirror is structured such that flat glass is deposited in multi layers as a non-metal material to utilize interference. Materials, and thickness and number of the layers are adjusted to select a reflection/transmission wavelength. Particularly, the first input optical mirror 420 formed of the dichroic mirror ensures low light loss due to absorption and thus appropriate for construction of the present embodiment whose purpose is to reduce light loss.

The second input optical mirror 410 has a surface applied with a metal selected from a group consisting of aluminum, silver and gold, and thus reflects the optical parametrically-converted beam through the non-linear material.

As set forth above, according to exemplary embodiments of the invention, an optical parametric oscillator including a plurality of output optical mirrors is employed to convert a laser beam into beams of a broader wavelength. Also, the optical parametric oscillator is minimized in light loss to ensure the laser beam to be outputted with higher efficiency.

While the present invention has been shown and described in connection with the exemplary embodiments, it will be apparent to those skilled in the art that modifications and variations can be made without departing from the spirit and scope of the invention as defined by the appended claims.

What is claimed is:

1. An optical parametric oscillator comprising:
a non-linear optical material optical parametrically converting a beam pumped from a laser; and
input and output optical devices opposing each other, the input and output optical devices guiding the optical parametrically-converted beam to the non-linear optical material to oscillate,
wherein the input optical device comprises an input optical mirror guiding the pumping beam into the oscillator, and
the output optical device comprises a plurality of output optical mirrors each guiding the optical parametrically-converted beam outside the oscillator, the output optical mirrors having ref lectivities different from one another with respect to a wavelength of the optical parametrically-converted beam.

2. The optical parametric oscillator of claim 1, wherein each of the output optical mirrors has a dielectric layer applied thereon.

3. The optical parametric oscillator of claim 2, wherein the dielectric layer comprises a plurality of dielectric layers.

4. The optical parametric oscillator of claim 1, wherein each of the output optical mirrors has a metal layer applied thereon.

5. The optical parametric oscillator of claim 1, wherein each of the output optical mirrors comprises a material selected from a group consisting of LiNbO₃, LiIO₃, AgGaS₂, ZnGeP₂, Te and glass.

6. The optical parametric oscillator of claim 1, wherein at least one of the output optical mirrors reflects the optical parametrically-converted beam.

7. The optical parametric oscillator of claim 1, wherein the input optical mirror comprises:
a first input optical mirror reflecting the pumping beam to be guided into the non-linear optical material and transmitting the optical parametrically-converted beam; and
a second input optical mirror reflecting the optical parametrically-converted beam passed through the first input optical mirror.

8. The optical parametric oscillator of claim 7, wherein the first input optical mirror is a dichroic mirror.

9. The optical parametric oscillator of claim 7, wherein the first input optical mirror has a reflectivity of at least 95% with respect to the pumping beam from the laser.

10. The optical parametric oscillator of claim 7, wherein the second input optical mirror has a surface applied with a metal selected from a group consisting of aluminum, sliver and gold.
